(19) United States
(12) Patent Application Publication
(10) Pub. No.: US 2023/0419187 A1
(43) Pub. Date: Dec. 28, 2023

(54) REINFORCEMENT LEARNING FOR DIVERSE CONTENT GENERATION

(71) Applicant: Spotify AB, Stockholm (SE)

(72) Inventors: Zhenwen Dai, London (GB); Joseph Cauteruccio, Boston, MA (US); Federico Tomasi, London (GB); Mehdi Ben Ayed, New York, NY (US)

(73) Assignee: Spotify AB, Stockholm (SE)

(21) Appl. No.: 17/851,426

(22) Filed: Jun. 28, 2022

(51) Int. Cl. G06N 20/10

(52) U.S. Cl. CPC G06N 20/10

(57) ABSTRACT

Methods, systems and computer program products are provided for content generation. A distribution of policies is defined based on an action space. Distribution parameters are received from a reinforcement learning (RL) algorithm. In turn, a policy is randomly sampled from the distribution of policies. A candidate content item is generated using the sampled policy. A quality of the candidate content item is measured based on a predefined quality criteria and a parameter model is adjusted as specified by the reinforcement learning algorithm to obtain a plurality of updated distribution parameters. Environment settings are passed to a trained parameter model to obtain a plurality of policy distribution parameters. A predetermined number of policies from the distribution of policies are then sampled and the plurality of environment settings are passed to the predetermined number of sampled policies to obtain at least one content item.

### TECHNICAL FIELD

Example aspects described herein relate generally to content generation systems, and more particularly to systems, methods and computer products for automatically generating diverse content using reinforcement learning.

### BACKGROUND

Reinforcement learning (RL) is a machine learning training framework concerned with how so-called reinforcement learning agents ought to take actions in an environment to maximize the notion of cumulative reward. RL has been used for media content generation by decomposing media content generation tasks into a sequence of incremental steps and using a reward definition to train an RL agent from both positive and negative rewards resulting from generated media content items. Despite the early success of RL for media content generation (RLfCG), there is a fundamental technical limitation in known RLfCG approaches. Different from typical RL tasks of sequential control that focus on finding a single optimal solution, the objective in content generation tasks is to generate rich and diverse content.

Quality metrics concerning the results of such RLfCG approaches are often based on a subjective quality. Moreover, drastically different content might be judged to be equally good. However, when surfaced repeatedly, the subjective quality of even the best single instance will degrade. This is, in part, because the RL mechanisms they use to select content still converge on one optimal policy and not a distribution of viable policies. For content generation systems, it is desirable that generated content not only meet predetermined criteria but also be sufficiently diverse.

### SUMMARY

The example embodiments described herein meet the above-identified needs by providing methods, systems and computer program products for generating content. In an example embodiment there is provided a content generator comprising at least one processor coupled to a non-transitory storage device storing instructions which, when executed by the at least one processor, cause the at least one processor to: randomly sample a policy from a distribution of policies to obtain a sampled policy, generate a candidate content item using the sampled policy, measure a quality of the candidate content item based on a predefined quality criteria, and adjust a parameter model as specified by a reinforcement learning algorithm to obtain a plurality of updated distribution parameters.

In some embodiments, the non-transitory storage device further stores instructions which, when executed by the at least one processor, cause the at least one processor to: receive a plurality of distribution parameters from the reinforcement learning (RL) algorithm.

In some embodiments, the non-transitory storage device further stores which, when executed by the at least one processor, cause the at least one processor to: define a distribution of policies based on an action space.

In some embodiments, the non-transitory storage device further stores which, when executed by the at least one processor, cause the at least one processor to: obtain a plurality of environment settings; pass the plurality of environment settings to a trained parameter model to obtain a plurality of policy distribution parameters; sample a predetermined number (K) of policies from the distribution of policies, thereby obtaining a predetermined number (K) of sampled policies; and pass the plurality of environment settings to the predetermined number (K) of sampled policies.

In some embodiments, the non-transitory storage device further stores which, when executed by the at least one processor, cause the at least one processor to: obtain at least one content item using the predetermined number (K) of sampled policies.

In some embodiments, the non-transitory storage device further stores which, when executed by the at least one processor, cause the at least one processor to: select from a database of content items at least one content item; and communicate the at least one content item to a playback device for playback.

In another embodiment there is provided a method for generating content including the steps of: randomly sampling a policy from a distribution of policies, thereby obtaining a sampled policy; generating a candidate content item using the sampled policy; measuring a quality of the candidate content item based on a predefined quality criteria; and adjusting a parameter model as specified by a reinforcement learning algorithm to obtain a plurality of updated distribution parameters, thereby obtaining an adjusted parameter model.

In some embodiments the method includes the step of receiving a plurality of distribution parameters from the reinforcement learning (RL) algorithm.

In some embodiments the method includes the step of defining a distribution of policies based on an action space.

In some embodiments the method includes the steps of obtaining a plurality of environment settings; passing the plurality of environment settings to a trained parameter model to obtain a plurality of policy distribution parameters; sampling a predetermined number (K) of policies from the distribution of policies, thereby obtaining a predetermined number (K) of sampled policies; and passing the plurality of environment settings to the predetermined number (K) of sampled policies.

In some embodiments the method includes the step of obtaining at least one content item using the predetermined number (K) of sampled policies.

In some embodiments the method includes the steps of selecting from a database of content items at least one content item; and communicating the at least one content item to a playback device for playback.

In yet further embodiments there is provided a non-transitory computer-readable medium having stored thereon one or more sequences of instructions for causing one or more processors to perform the methods described herein.

### BRIEF DESCRIPTION OF THE DRAWINGS

The features and advantages of the example embodiments of the invention presented herein will become more apparent from the detailed description set forth below when taken in conjunction with the following drawings.

FIG. 1 illustrates a content generator according to an example embodiment.

FIG. 2 depicts a content generation procedure for generating content according to an example embodiment.

FIG. 3 illustrates an example valid-content policy distribution selected from a prior policy distribution according to an example application.

FIG. 4 depicts a procedure for performing parameter modeling according to an example embodiment.

FIG. 5 depicts pseudocode for performing parameter model training using a stochastic variational policy inference (SVPI) algorithm according to an example implementation of a parameter model training procedure.

FIG. 6 depicts a procedure for performing policy inference according to an example embodiment.

### DETAILED DESCRIPTION

As used herein a policy inference is a mechanism that allows a reinforcement learning (RL) agent to infer a policy of the RL agent through interaction. Policy inference is data-efficient and is particularly useful when data are time-consuming or require resource intensive computational tasks (e.g., costly) to obtain.

Generally, example aspects of the embodiments described herein provide a Bayesian framework for policy inference in RL for media content generation (RLfCG) that infers a posterior distribution of policies that all generate content. “Posterior”, in this context, means after taking into account the relevant evidence related to the particular case being examined. A posterior probability distribution is a probability distribution of an unknown quantity, treated as a random variable, conditional on the evidence obtained from an experiment or survey. Stated differently, a posterior probability distribution is a probability distribution that represents revised or updated probabilities of events occurring after taking into consideration new information.

Bayesian inference is a method of statistical inference in which Bayes' theorem is used to update the probability for a hypothesis as more evidence or information becomes available. Generated content that meets certain criteria is regarded as valid content and the validity score is treated as a pseudo-likelihood in Bayesian inference.

In some embodiments, a posterior policy distribution of policies, provides a distribution of policies that can generate valid content within the scope specified based, at least in part, on an uninformative prior distribution of policies. By defining a wide, uninformative prior distribution for policies, a posterior policy distribution that can be interpreted as the distribution of policies that are able to generate valid content within the scope specified by the prior distribution of policies are inferred. In some embodiments, the exact posterior distribution of policies is intractable because it marginalizes over the space of state and action series as well as a policy parameter space.

A policy parameter space, as used herein, is the space of possible policy parameter values that define a particular policy model, for example as a subset of a finite-dimensional Euclidean space. The parameters can be inputs of a function, in which case the technical term for the policy parameter space is a domain of a function.

Aspects of the embodiments described herein use technology to select content from a corpus of content based on a distribution of viable policies in a manner that removes subjective judgement and improves diversity of selected content.

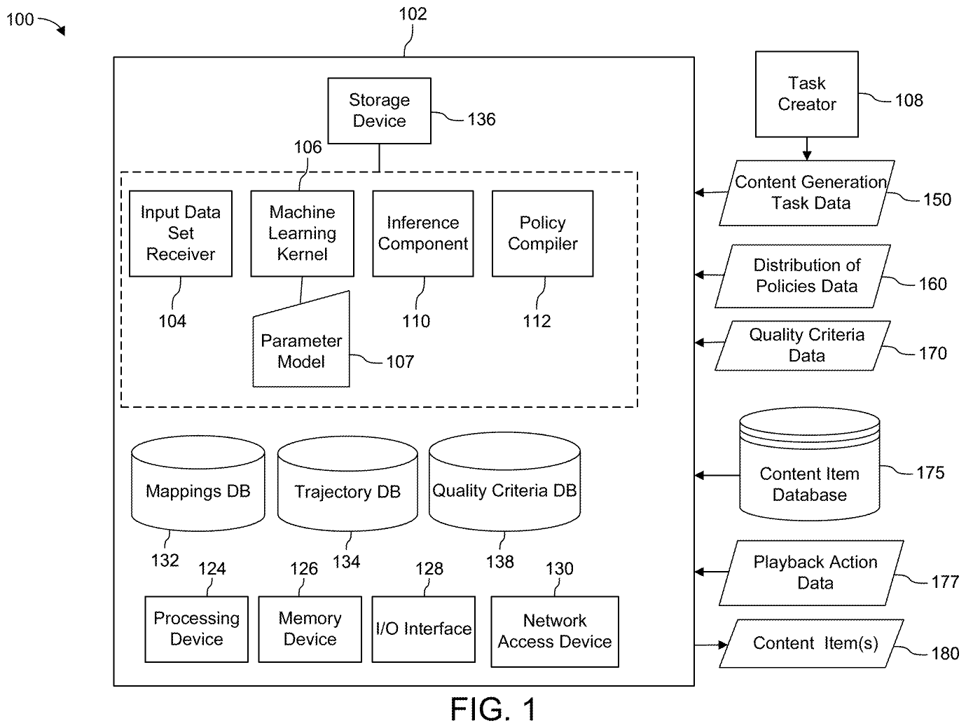

FIG. 1 illustrates a content generator system 100 according to an example embodiment. In the example of FIG. 1, the content generator system 100 includes a content generator 102, a task creator 108, and a content item database 175. Content generator 102 includes an input data set receiver 104, a machine learning kernel 106, an input inference component 110, a policy compiler 112, a processing device 124, a memory device 126, a storage device 136, an input/output (I/O) interface 128, a network access device 130, a mappings database 132, a trajectory database 134, and a quality criteria database 138.

In an example embodiment, the processing device 124 also includes one or more central processing units (CPUs). In another example embodiment, the processing device 124 includes one or more graphic processing units (GPUs). In other embodiments, the processing device 124 may additionally or alternatively include one or more digital signal processors, field-programmable gate arrays, or other electronic circuits as needed.

The memory device 126 (which as explained below is a non-transitory computer-readable medium), coupled to a bus, operates to store data and instructions to be executed by processing device 124. The instructions, when executed by processing device 124 can operate as input data set receiver 104, machine learning kernel 106, input inference component 110 and policy compiler 112. The memory device 126 can be, for example, a random-access memory (RAM) or other dynamic storage device. The memory device 126 also may be used for storing temporary variables (e.g., parameters) or other intermediate information during execution of instructions to be executed by processing device 124.

The storage device 136 also is a non-transitory computer-readable medium and may be a nonvolatile storage device for storing data and/or instructions for use by processing device 124. The storage device 136 may be implemented, for example, with a magnetic disk drive or an optical disk drive. In some embodiments, the storage device 136 is configured for loading contents of the storage device 136 into the memory device 126.

I/O interface 128 includes one or more components which a user of the content generator 102 can interact. The I/O interface 128 can include, for example, a touch screen, a display device, a mouse, a keyboard, a webcam, a microphone, speakers, a headphone, haptic feedback devices, or other like components.

Examples of the network access device 130 include one or more wired network interfaces and wireless network interfaces. Examples of such wireless network interfaces of a network access device 130 include wireless wide area network (WWAN) interfaces (including cellular networks) and wireless local area network (WLANs) interfaces. In other implementations, other types of wireless interfaces can be used for the network access device 130.

The network access device 130 operates to communicate with components content generator 102 can communicate with over various networks. Such components outside the content generator 102 can be, for example, one or more sources of input data, such as which provide content generate task data 150 and distribution of policies data 160. In addition, such components outside the content generator 102 can include content distribution systems that distribute content items, such as content item(s) 180 that are generated by content generator 102 (e.g., in the form of media content item identifiers).

The mappings database 132, trajectory database 134 and quality criteria database 138 are, in some embodiments, located on a system independent of, but communicatively coupled to, content generator 102.

In some embodiments, memory device 126 and/or storage device 136 operate to store instructions, which when executed by one or more processing devices 124, cause the one or more processing devices 124 to operate as any one or a combination of input data set receiver 104, machine learning kernel 106, input inference component 110 and policy compiler 112.

Input data set receiver 104 is configured to receive task data 150 for content generation and distribution of policies data 160. Task creator 108 is configured to define a content generation task by obtaining an action space, a plurality of state definitions, and rewards associated with a particular environment.

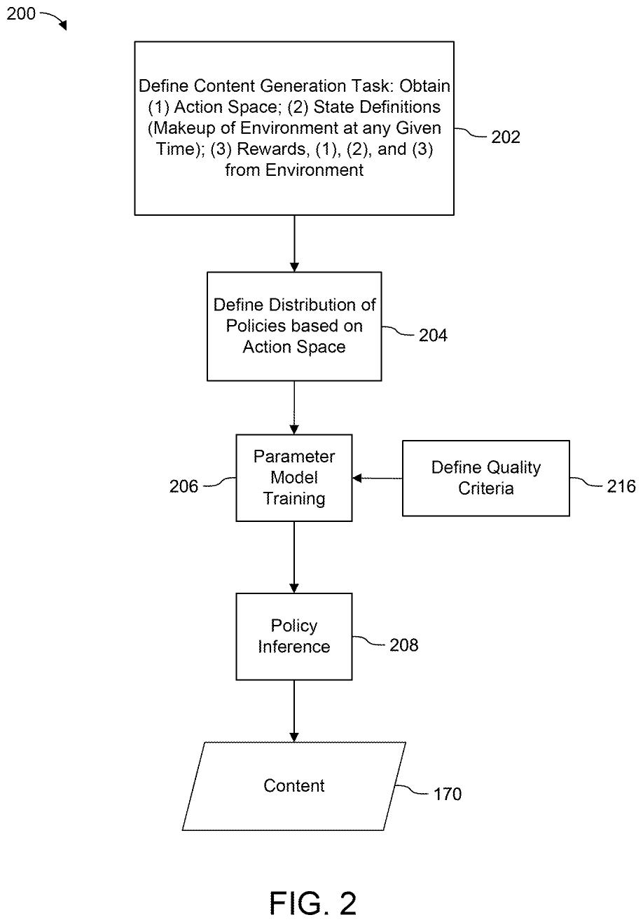

In an example embodiment, input data set receiver 104 is configured to receive content generation task data 150 and distribution of policies data 160. Task creator 108 is configured to define, based on the content generation task data 150, a content generation task, according to a content generation procedure as described herein in connection with of FIG. 2.

In some embodiments, content generator 102 includes task creator 108. In this example embodiment, memory device 126 and/or storage device 136 operate to store instructions, which when executed by one or more processing devices 124, cause the one or more processing devices 124 to operate as task creator 108.

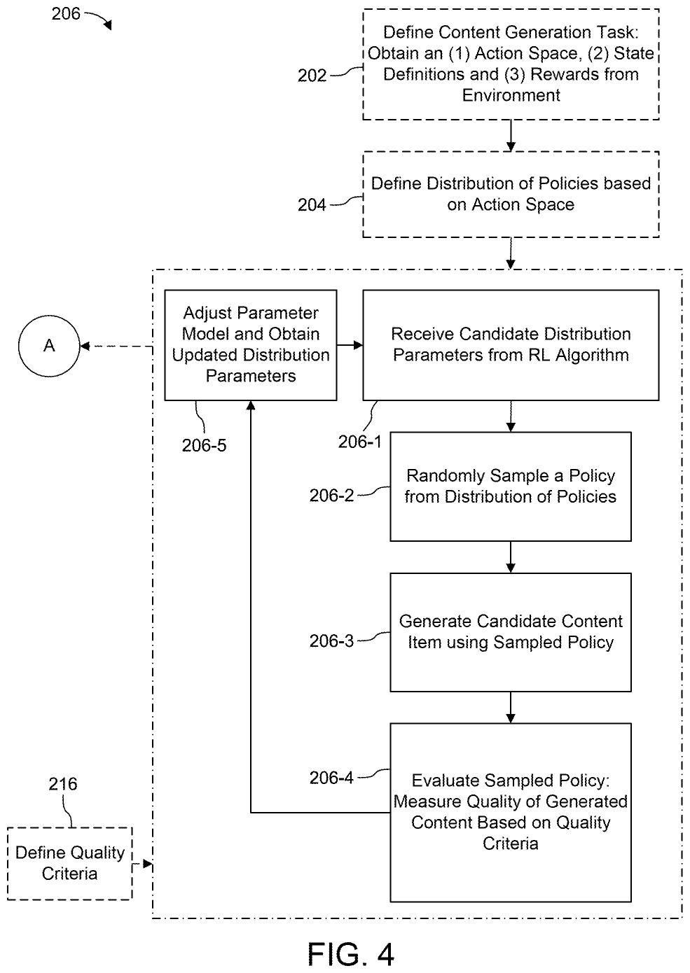

Machine learning kernel 106 is configured to perform parameter model training. In an example embodiment, machine learning kernel 106 operates to train a parameter model 107 according to a procedure for performing parameter modeling described herein in connection with FIG. 4.

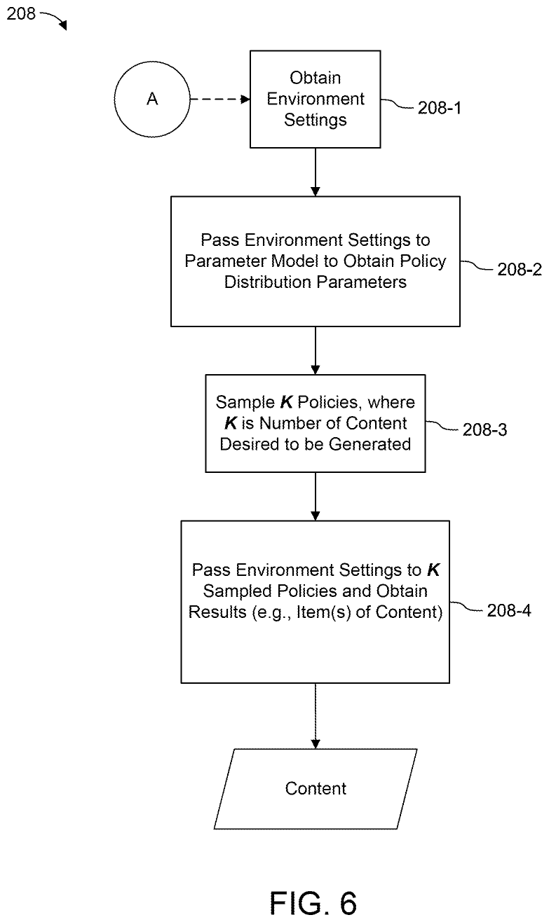

Input inference component 110 is configured to generate content item(s) 180. In an example embodiment, input inference component 110 is configured to generate content item(s) 180 according to a procedure for performing policy inference described herein in connection with FIG. 6.

In some embodiments, input inference component 110 is configured to generate content item(s) 180 by obtaining content item identifiers according to the procedure for performing policy inference described in FIG. 6.

FIG. 2 depicts a content generation procedure 200 for generating content according to an example embodiment. Content generation procedure 200 includes a task definition operation 202, a distribution defining operation 204, a parameter model training procedure 206 and a policy inference procedure 208.

Task definition operation 202 performs defining a content generation task. A content generation task, as used herein, is a task associated with the generating content. In an example implementation, the task definition operation 202 includes obtaining an action space, state definitions and rewards from the environment.

As used herein, a state space is a set of all the states that an agent can transition to, and an action space is a set of all actions the agent can act out in a certain environment. A state definition, as used herein, is a makeup of an environment at any given time.

In turn, distribution defining operation 204 performs defining distribution of policies based on the action space. The distribution of policies generates what is referred to herein as valid content. In an example embodiment, policy compiler 112 is configured to define the distribution of policies based on an action space is receives.

In an example implementation “r” is a binary indicator variable used to specify whether the state of content that is automatically generated is valid (“valid content”) or invalid (“invalid content”). For example, r can be one of {0, 1} where r=0 represents invalid content and r=1 represents valid content.

A quality defining operation 216 performs defining a measure of a quality. The measure of quality data is fed to the parameter model training procedure 206.

In an example embodiment, the quality data is stored in quality criteria database 138. In an example embodiment, quality defining operation 216 receives quality criteria data 170 from a system with which content generator 102 communicates (e.g., over a network). In an example implementation, quality criteria data 170 is predefined. More specifically the quality criteria data 170 includes validity checks for individual actions such that content that is generated is valid if all the individual actions are determined by content generator 102 to be valid. In an example embodiment, the value of the validity is in the form of a probability (referred to as a validity probability).

Parameter model training procedure 206 performs machine learning using a reinforcement learning algorithm to obtain distribution parameters, thereby obtaining a parameter model. As explained below, the parameter model is dynamic in that it can be updated.

Policy inference procedure 208, in turn, uses the parameter model to automatically generate content.

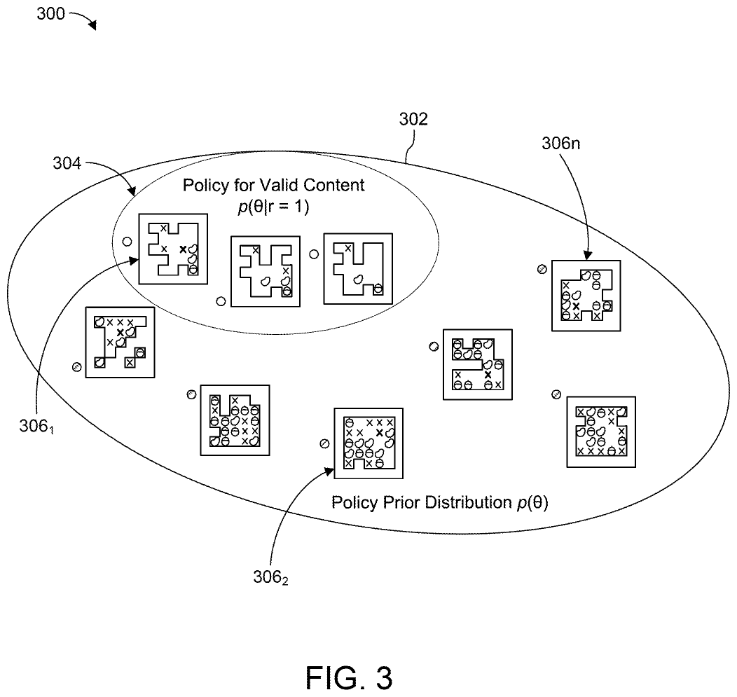

FIG. 3 illustrates a valid-content policy distribution 300 selected from a prior policy distribution according to an example application. A prior policy distribution p(θ) 302 (also referred to as “policy prior distribution” or “prior distribution of policy”) defines the bounds of a policy distribution. A valid content policy distribution p(θ|r=1) 304 defines a distribution of policies that generate valid content. As used herein, a particular policy is denoted by θ, p(θ) denotes a prior distribution of a particular policy θ. q(θ) denotes an approximate posterior distribution of the particular policy θ.

Referring again to FIG. 2, in some embodiments, the distribution defining operation 204 performs defining types of policies that will be produced based on a type of content being generated. The type of content being generated specifies the allowable action space and thus, ultimately the policy distribution being learned (e.g., valid content policy distribution p(θ|r=1) 304). In the example application depicted in FIG. 3, the content being generated includes one or more game levels depicted by symbols 306₁, 306₂, . . . , 306ₙ (each generally referred to herein as a content item 306). A policy of prior policy distribution p(θ) in this example application is a policy that performs an action to construct the content (e.g., a game level type content item 306). A policy leads to a series of actions and the outcome of a policy produces a result (e.g., a construction of one or more game levels). In the example use case depicted in FIG. 3, each action of a policy will perform a small modification to a current game level design. The RL environment, which is defined in terms of state, action and reward, along with priors on the policy distribution, define a starting point that maps to policies for valid content 304. States are a representation of the current world or environment of the task. Actions are something an RL agent can do to change these states. Rewards are the utility the agent receives for performing the “right” actions. Thus, the states tell the agent what situation it is in currently, and the rewards signal the states that it should be aspiring towards.

The content to be generated and the action the policy needs to take to construct the content, along with the prior policy distribution, also referred to as priors define a starting point for parameter modeling training, discussed in more detail below.

In addition to specifying the bounds of the prior policy distribution p(θ) a quality defining operation 216 performs defining a measure of a quality. In some embodiments, quality defining operation 216 is performed prior to parameter modeling. In some embodiments, quality defining operation 216 is performed by receiving, via a user interface, a numerical value. The numerical value representing the measure of quality depends on the type of content to be generated. The numerical values are mapped to the type of content to be generated. A mapping of numerical values representing the measure of quality can be prestored, for example, in a mappings database 132.

If a numerical value is not entered, a default value can be used. A default value can be based, for example, on a particular task is used. A mapping of default values to particular tasks can be prestored, for example, in mappings database 132.

Once the bounds of the prior policy distribution p(θ) are specified, parameter modeling is performed.

FIG. 4 depicts a procedure for performing parameter model training 206 of FIG. 3 according to an example embodiment. The procedure for performing parameter model training 206 includes a receiving operation 206-1, a sampling operation 206-2, a generating operation 206-3, an evaluation operation 206-4, and an adjusting operation 206-5.

Receiving operation 206-1 performs receiving a plurality of distribution parameters from a reinforcement learning (RL) algorithm. In turn, sampling operation 206-2 performs randomly sampling a policy from the distribution of policies, thereby obtaining a sampled policy. The generating operation 206-3 performs generating a candidate content item using the sampled policy, and the evaluation operation 206-4 performs measuring a quality of the candidate content item based on the predefined quality criteria described above in connection with quality defining operation 216. In turn, adjusting operation 206-5 performs adjusting a parameter model as specified by the reinforcement learning algorithm to obtain a plurality of updated distribution parameters, thereby obtaining an adjusted parameter model.

In some embodiments, generating a candidate content item is performed by generating a content item identifier that points to the candidate content item.

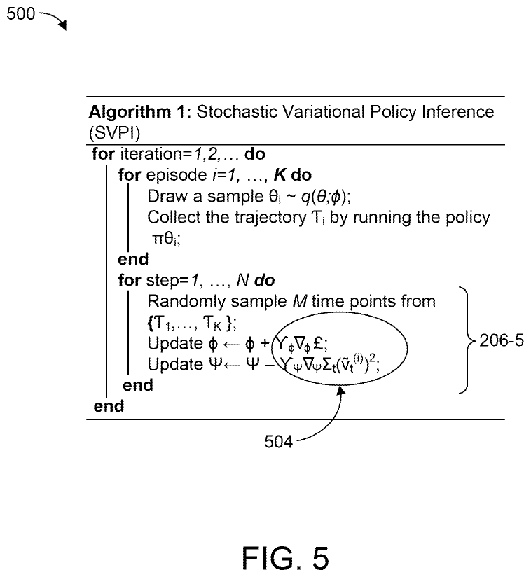

FIG. 5 depicts pseudocode for performing parameter model training using a stochastic variational policy inference (SVPI) algorithm according to an example implementation of parameter model training procedure 206. Training in this example implementation is based on a SVPI method that optimizes a variational posterior distribution over policies. The variational posterior distribution over policies minimizes a Kullback-Leibler (KL) divergence between the variational posterior distribution and the true posterior distribution. An on-policy method is a method that attempts to evaluate or improve a policy that is used to make decisions. In this example implementation, a derived variational lower bound treats data logged from an environment as Monte Carlo samples from a Markov Decision Process (MDP) and approximates the integral over the policy posterior via sampling. The resulting variational inference method can be viewed as an on-policy method in which the policy posterior is iteratively updated. To improve training efficiency, a variational lower bound with an importance sampling correction that allows multiple gradient steps to be taken from a recorded episode is derived.

In the description that follows, one iteration of the loop shown in FIG. 5 corresponds to one iteration of the SVPI algorithm. A description of an example parameterization structure is now described.

A generative distribution “q” is parameterized by ϕ and generates policy parameters θ. θᵢ˜ q(θ;ϕ) means a distribution for which policy parameters θ has a distribution q parameterized by ϕ. “i” is an integer number from 1 to K. θᵢ indicates a sample of a set of policy parameters. In some embodiments, θᵢ indicates a random sample of a set of policy parameters. π_{θ}_{ᵢ} is a policy that is complete (it is parameterized by a set of policy parameters θᵢ). π without a subscript can be analogized to a scaffold. It provides the types of actions that can be performed but has no ability to actually perform the actions. In other words, π_{θ}_{ᵢ} is a policy that has an ability to perform the actions.

Traditional methods typically select only one set of policy parameters. Some existing methods use “policy data” to define the set of policy parameters.

In the example embodiments described herein, a distribution θᵢ˜ q(θ;ϕ) is learned by finding ϕ so as many sets of policy parameters (θs) as necessary can be generated and thus, just as many policies. Each set of policy parameters θᵢ is used to generate a policy Rei so that the number of policy parameters corresponds to the number of policies.

Because a distribution is implemented, each set of policy parameters (θᵢ) is different and thus the behavior of each policy parametrized by that theta π_{θ}_{ᵢ} is a relatively slightly different. As a result, the content each policy (π_{θ}_{ᵢ}) generates is relatively different. In an example implementation, the content each policy (π_{θ}_{ᵢ}) generates is quantitatively slightly different.

As described above, receiving operation 206 performs receiving a plurality of distribution parameters from a reinforcement learning (RL) algorithm. In an example implementation, ϕ and ψ are the distribution parameters. A ϕ distribution parameter is a parameter of a variational posterior distribution of policy. A ψ parameter is a parameter corresponding to a baseline function. In the example implementation of receiving operation 206, at each iteration of the training loop, receiving operation 206 performs receiving the current state of the ϕ distribution parameters and the current state of the ψ parameters.

In the very first iteration of the parameter model training depicted in FIG. 5, the distribution parameters ϕ and ψ will be naive starting values. The starting values of distribution parameters ϕ and ψ are determined by an assumption made about the policy distribution a priori. An assumption made about the policy distribution is referred to as a prior.

As described above, sampling operation 206-2 performs randomly sampling a policy from the distribution of policies, thereby obtaining a sampled policy. In an example implementation, the sampling operation 206-2 performs, at each iteration, random sampling of policies from the policy distribution, as determined by distribution parameter ϕ. The number of random samples is K, where K is an integer. As a result, K sample policies π_{θ}_{₁} . . . π_{θ}_{_{K}} are obtained by sampling θ K times (θ₁ . . . θ_{K}) from the distribution θᵢ˜q(θ; ϕ). In turn, policies π_{θ}_{ᵢ} . . . π_{θ}_{_{K}} are used to produce the K random policies. That is, a sampling operation 206-2 performs sampling of K random samples (i.e., Bi, K times), and the K random samples are used to generate K policies π_{θ}_{₁}, . . . π₇₄ _{_{K}}. In turn, a collection operation collects from each policy, a trajectory τᵢ. The policies π_{θ}_{ᵢ} are then used to generate a candidate content item.

In an example embodiment, trajectory database 134 of FIG. 1 stores trajectory τᵢ.

As described above, the generating operation 210 performs generating a candidate content item using the sampled policy. Referring to the example implementation of FIG. 5, the generating operation 210 includes using the sampled policies π_{θ}_{₁} to . . . π_{θ}_{_{K}} to generate the candidate content. This is performed, for example, by executing a sampled policy π_{θ}_{_{K}} and causing the sampled policy π_{θ}_{_{K}} to generate candidate content. The start to finish execution of a policy π_{θ}_{_{K}} is referred to herein as an “episode” and thus the K random policies that execute start to finish yields K episodes. In reinforcement learning terminology, a trajectory T is a sequence of what has happened (in terms of state, action, reward) over a set of contiguous timestamps, from a single episode, or a single part of a continuous problem. In the example implementation according to the embodiments described herein, the generating operation 210 performs collecting state data, action data and reward data corresponding to each policy π_{θ}_{_{K}}. The collected state data, action data and reward data are stored in what is called a trajectory, τ. In other words, collected state data is everything that is included in the trajectories, τ, including observations of the environment (i.e., state), actions and rewards. In an example implementation, the trajectory is stored in a trajectory database 122.

The K episodes generated from running policies π_{θ1} . . . π_{θ}_{_{K}} are represented by the K trajectories τ₁ . . . τ_{K}. In this example implementation, K is an integer representing a number of episodes.

At the first stage of training these trajectories τ₁ . . . τ_{K} would each be a content item in a prior policy distribution p(θ). In some embodiments, the distribution parameters ϕ and ψ are updated. As the distribution parameters ϕ and ψ are updated, the policy distribution q(θ; ϕ) improves and the generated episodes approach the distribution of polices that generate valid content a policy for valid content policy distribution p(θ|r=1).

As described above, the evaluation operation 212 performs measuring a quality of the candidate content item based on the predefined quality criteria described above in connection with quality defining operation 216. In the example implementation of FIG. 5, the results are mappings for distribution parameters ϕ and ψ. Parameters are updated by summing the same parameter results of the previous iteration with the new values for ϕ and ψ 504.

As described above, an adjusting operation 206-5 performs adjusting a parameter model as specified by the reinforcement learning algorithm to obtain a plurality of updated distribution parameters, thereby obtaining an adjusted parameter model. In the example implementation of FIG. 5, this is performed to measure how good the generated content is. The calculation of this “goodness” as defined by the content quality criteria yields the values [symbol] and \tilde{v}hd t⁽ⁱ⁾. vₜ is the sum of the validity scores from the time t. For purposes of an update, vₜ can be noisy (i.e., have a high variance). In such cases, the variance of the gradient can be reduced by learning a neural network baseline function Cψ (s<t, θ) where the vₜ is: \tilde{v}ₜ⁽ⁱ⁾=v(i)t˜Cψ(S(i)<t, θᵢ), which is essentially a corrected version of a validity score sum to account for high variance. Thus \tilde{v}ₜ⁽ⁱ⁾ is a variance-reduced sum of validity scores at time-f adjusted via the use of a baseline function and G is the Evidence Lower Bound or the loss function.

An example adjusting operation 206-5 is depicted in the implementation of FIG. 5. The adjusting operation 206-5 in this example implementation uses the measurements of “goodness” to update ϕ and ψ (as represented by ∇). ∇ represents a specific operation related to how to calculate the update itself (i.e., an operation to find updates for a differentiable loss function).

Adjusting operation 206-5 updates distribution parameters ϕ and ψ to new (e.g., improved) values that will be used in the next iteration. Updated distribution parameters ϕ and ψ are used in the next stage in the overall process, which is the policy inference procedure 208 described below in more detail in connection with FIG. 6.

FIG. 6 depicts a procedure for performing policy inference 208 according to an example embodiment. Policy inference procedure 208 includes an environment receiving operation 208-1, a policy-distribution-parameters receiving operation 208-2, a policy sampling operation 208-3 and a policy execution operation 208-4. Collectively, environment receiving operation 208-1, policy distribution parameters receiving operation 208-2, policy sampling operation 208-3 and policy execution operation 208-4 perform policy inference and content selection.

In some embodiments, environment receiving operation 208-1 performs obtaining a plurality of environment settings (e.g., environment settings include action space, state definitions and rewards). In turn, policy distribution parameters receiving operation 208-2 performs passing the plurality of environment settings to a trained parameter model (e.g., such as parameter model 107 of FIG. 1) which is the result of parameter model training procedure 206 to obtain a plurality of policy distribution parameters. Policy sampling operation 208-3 performs sampling a predetermined number (K) of policies from the distribution of policies, thereby obtaining a predetermined number (K) of sampled policies. In turn, policy execution operation 208-4 performs passing the plurality of environment settings to the predetermined number (K) of sampled policies to obtain at least one content item.

In some embodiments, the content generation task is a music recommendation task. In an example embodiment, a media content playlist lists media content items to be played back on a media playback device. The media content playlist is constructed based on the playback actions performed on particular media content items on the playlist played back on the media playback device. In an example embodiment data corresponding to actions performed via the media playback device are received by the content generator 102 over a network via network access device 130. Playback action data is represented in FIG. 1 as playback action data 177.

The media content items (e.g., in the form of media content item identifiers) can be stored on a media content item distribution system. For simplicity, an example content item database 175 configured to store media content items is shown in FIG. 1.

Each time another media content item (e.g., music track) is selected, either because the current media content item has finished or has been skipped before it ends, the RL agent will present the next media content item based on the interactions with the playlist thus far. The generated content in this case is the list of media content items (e.g., a playlist) that the RL agent presents to a user and the reward is to minimize the number of skipped media content items (e.g., tracks).

In an example application, a dataset includes a streaming session dataset. The streaming session dataset, for example, contains listening sessions up to a predetermined number of tracks (e.g., 20).

Long short-term memory (LSTM) is an artificial recurrent neural network (RNN) architecture used in the field of deep learning. Unlike standard feedforward neural networks, LSTM has feedback connections. It can process not only single data points (such as images), but also entire sequences of data (such as speech or video).

For example, LSTM is applicable to tasks such as unsegmented, connected handwriting recognition, speech recognition and anomaly detection in network traffic or IDSs (intrusion detection systems).

In an example embodiment, a LSTM model is trained to predict a user's response “non skip”, “skip 1”, “skip 2” and “skip 3” as provided in the dataset conditioned on the features of the media content items. In an example application, media content item features include attributes such as acoustic properties, popularity estimates and artist-summary information. Once trained, the LSTM model is used to simulate user responses in the RL agent environment.

An agent is trained by sampling observed sessions of a constant length (20) from the streaming dataset and each user-session serves as an episode start. The observation is always a sequence of a predetermined number of media content items (e.g., 5-tracks), their features, and the outcome. At step-0 the sequence included the first predetermined number of media content items (e.g., 5 tracks) impressed on user as well as the ground truth responses. The action space is a discrete media content item (e.g., track) selection from a candidate set comprised of the remaining observed sessions of constant length (e.g., 15 tracks) in the recorded session. In an example application, the RL agent cannot select a repeated media content item in the same listening session. The LSTM mentioned above then predicts the skip response for the media content item the agent selects conditioned on the observation, after which the reward is recorded and the observation is updated. The reward of a listening session is the number of non-skipped tracks.

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terminology used herein is for the purpose of describing particular examples only and is not intended to be limiting. As used herein, the singular forms “a”, “an” and “the” are intended to include the plural forms as well, unless the context clearly indicates otherwise.

Spatially relative terms, such as “under”, “below”, “lower”, “over”, “upper” and the like, may be used herein for ease of description to describe one element or feature's relationship to another, for example when the apparatus is right side up.

Illustrative examples of the disclosure are described below. In the interest of clarity, not all features of an actual implementation are described in this specification. It will of course be appreciated that in the development of any such actual example, numerous implementation-specific decisions must be made to achieve the developers' specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

Software embodiments of the example embodiments presented herein may be provided as a computer program product, or software, that may include an article of manufacture on a machine accessible or machine readable medium having instructions. The instructions on the machine accessible or machine readable medium may be used to program a computer system or other electronic device. The machine-readable medium may include, but is not limited to, optical disks, CD-ROMs, and magneto-optical disks or other type of media/machine-readable medium suitable for storing or transmitting electronic instructions. The techniques described herein are not limited to any particular software configuration. They may find applicability in any computing or processing environment. The terms “machine accessible medium” or “machine readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result.

The performance of the one or more actions enables enhanced and automated selection and output of the data corresponding to media content. This means that data which is selected and output according to the processes described herein are of enhanced contextual relevance and in this regard can be automatically selected and output at significantly improved rates, for example the throughput of data selection to its output, or speed of data selection is significantly enhanced. The data which is automatically selected and output according to the processes described herein can thus be pre-emptively obtained and stored locally within a computer, or transmitted to the computer, such that the selected data is immediately accessible and relevant to a local user of the computer.

Not all of the components are required to practice the invention, and variations in the arrangement and type of the components may be made without departing from the spirit or scope of the invention. As used herein, the term “component” is applied to describe a specific structure for performing specific associated functions, such as a special purpose computer as programmed to perform algorithms (e.g., processes) disclosed herein. The component can take any of a variety of structural forms, including: instructions executable to perform algorithms to achieve a desired result, one or more processors (e.g., virtual or physical processors) executing instructions to perform algorithms to achieve a desired result, or one or more devices operating to perform algorithms to achieve a desired result.

While various example embodiments of the present invention have been described above, it should be understood that they have been presented by way of example, and not limitation. It will be apparent to persons skilled in the relevant art(s) that various changes in form and detail can be made therein. Thus, the present invention should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. A content generator, comprising:
at least one processor coupled to a non-transitory storage device storing instructions which, when executed by the at least one processor, cause the at least one processor to:
randomly sample a policy from a distribution of policies to obtain a sampled policy;
generate a candidate content item using the sampled policy;
measure a quality of the candidate content item based on a predefined quality criteria; and
adjust a parameter model as specified by a reinforcement learning algorithm to obtain a plurality of updated distribution parameters.

2. The content generator according to claim 1, the non-transitory storage device further storing instructions which, when executed by the at least one processor, cause the at least one processor to:
receive a plurality of distribution parameters from the reinforcement learning (RL) algorithm.

3. The content generator according to claim 1, the non-transitory storage device further storing instructions which, when executed by the at least one processor, cause the at least one processor to:
define a distribution of policies based on an action space.

4. The content generator according to claim 1, the non-transitory storage device further storing instructions which, when executed by the at least one processor, cause the at least one processor to:
obtain a plurality of environment settings;
pass the plurality of environment settings to a trained parameter model to obtain a plurality of policy distribution parameters;
sample a predetermined number (K) of policies from the distribution of policies, thereby obtaining a predetermined number (1) of sampled policies; and
pass the plurality of environment settings to the predetermined number (K) of sampled policies.

5. The content generator according to claim 4, the non-transitory storage device further storing instructions which, when executed by the at least one processor, cause the at least one processor to:
obtain at least one content item using the predetermined number (K) of sampled policies.

6. The content generator according to claim 1, the non-transitory storage device further storing instructions which, when executed by the at least one processor, cause the at least one processor to:
select from a database of content items at least one content item; and
communicate the at least one content item to a playback device for playback.

7. A content generation method, comprising:
randomly sampling a policy from a distribution of policies, thereby obtaining a sampled policy;
generating a candidate content item using the sampled policy;
measuring a quality of the candidate content item based on a predefined quality criteria; and
adjusting a parameter model as specified by a reinforcement learning algorithm to obtain a plurality of updated distribution parameters, thereby obtaining an adjusted parameter model.

8. The method according to claim 7, further comprising:
receiving a plurality of distribution parameters from the reinforcement learning (RL) algorithm.

9. The method according to claim 7, further comprising:
defining a distribution of policies based on an action space.

10. The method according to claim 7, further comprising:
obtaining a plurality of environment settings;
passing the plurality of environment settings to a trained parameter model to obtain a plurality of policy distribution parameters;
sampling a predetermined number (K) of policies from the distribution of policies, thereby obtaining a predetermined number (K) of sampled policies; and
passing the plurality of environment settings to the predetermined number (K) of sampled policies.

11. The method according to claim 10, further comprising:
obtaining at least one content item using the predetermined number (K) of sampled policies.

12. The method according to claim 7, further comprising:
selecting from a database of content items at least one content item; and
communicating the at least one content item to a playback device for playback.

13. A non-transitory computer-readable medium having stored thereon one or more sequences of instructions for causing one or more processors to perform:
randomly sampling a policy from a distribution of policies, thereby obtaining a sampled policy;
generating a candidate content item using the sampled policy;
measuring a quality of the candidate content item based on a predefined quality criteria; and
adjusting a parameter model as specified by a reinforcement learning algorithm to obtain a plurality of updated distribution parameters, thereby obtaining an adjusted parameter model.

14. The non-transitory computer-readable medium of claim 13, further having stored thereon a sequence of instructions for causing the one or more processors to perform:
receiving a plurality of distribution parameters from the reinforcement learning (RL) algorithm.

15. The non-transitory computer-readable medium of claim 13, further having stored thereon a sequence of instructions for causing the one or more processors to perform:
defining a distribution of policies based on an action space.

16. The non-transitory computer-readable medium of claim 13, further having stored thereon a sequence of instructions for causing the one or more processors to perform:
obtaining a plurality of environment settings;
passing the plurality of environment settings to a trained parameter model to obtain a plurality of policy distribution parameters;
sampling a predetermined number (K) of policies from the distribution of policies, thereby obtaining a predetermined number (K) of sampled policies; and
passing the plurality of environment settings to the predetermined number (K) of sampled policies.

17. The non-transitory computer-readable medium of claim 16, further having stored thereon a sequence of instructions for causing the one or more processors to perform:
obtaining at least one content item using the predetermined number (K) of sampled policies.

18. The non-transitory computer-readable medium of claim 13, further having stored thereon a sequence of instructions for causing the one or more processors to perform:
selecting from a database of content items at least one content item; and
communicating the at least one content item to a playback device for playback.
